(19) United States
(12) Patent Application Publication
(10) Pub. No.: US 2008/0259303 A1
(43) Pub. Date: Oct. 23, 2008

(54) PROJECTION EXPOSURE APPARATUS FOR MICROLITHOGRAPHY

(75) Inventors: Jens Ossmann, Aalen (DE); Martin Endres, Koenigsbronn (DE); Ralf Stuetzle, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/103,185

(22) Filed: Apr. 15, 2008

(30) Foreign Application Priority Data
Apr. 19, 2007 (DE) 10 2007 018 867.8

(51) Int. Cl. G03B 27/70; G03B 27/54

(52) U.S. Cl. 355/66; 355/67

(57) ABSTRACT

A projection exposure apparatus for microlithography is disclosed. The apparatus can include a radiation source to generate illumination radiation and a reticle holder to receive a reticle in an object plane. The apparatus can further include illumination optics to guide the illumination radiation to an object field, which is to be illuminated, in the object plane. The apparatus can also include a wafer holder to receive a wafer in an image plane and projection optics to image the object field into an image field in the image plane. The radiation source and projection optics can be arranged in separate chambers (e.g., one above the other). The chambers can be separated by a wall. There can be an illumination radiation leadthrough in the wall. In some embodiments, the projection exposure apparatus can guide the illumination radiation with low loss.

### CROSS-REFERENCE TO RELATED APPLICATION

This application claims priority to German patent application 10 2007 018 867.8, filed Apr. 19, 2007, the contents of which are hereby incorporated by reference.

### FIELD

The disclosure concerns a projection exposure apparatus for microlithography.

### BACKGROUND

Projection exposure apparatuses are known.

A central aspect of the implementation of a projection exposure apparatus is the provision of efficient illumination of the object field. It is typically desirable for the largest possible proportion of the illumination radiation which is generated in the radiation emitter of the radiation source should reach the object field. In particular, it is generally the case that short wave illumination radiation, e.g. in the EUV (extreme ultraviolet) range between 10 nm and 30 nm, can be guided efficiently and with low loss only via reflection mirrors. In this case, it can be desirable to use as small a number of mirrors as possible because losses can occur at every reflection. For EUV radiation and small angles of incidence, typical maximum reflection rates of 65% are achieved. This means that about a third of the incident EUV radiation is lost at every reflection. Also, particularly in the case of EUV illumination radiation, it can be advantageous for mirrors to be operated either at close to perpendicular incidence, i.e. with angles of incidence which are less than 25°, in particular less than 20°, or with angles of incidence which are close to grazing incidence, i.e. with angles of incidence which are greater than 70°. The nearer the angle of incidence is to 0° on the one hand or 90° on the other, the higher is the achievable reflection rate. In the case of known projection exposure apparatuses, these conditions, “small number of mirrors” and “angle of incidence close to perpendicular or grazing incidence” generally cannot be combined. Since the radiation sources are sometimes of considerable size, in the case of known projection exposure apparatuses illumination radiation is usually emitted by the radiation source in an approximately horizontal direction, whereas the direction of the illumination radiation immediately before the reticle is almost vertical. This means that the main beam of the illumination radiation in the illumination optics should be deflected by about 90°, which on the one hand involves a minimum number of mirrors resulting in unavoidable reflection losses, and on the other hand involves angles of incidence which are relatively far from perpendicular or grazing incidence.

### SUMMARY

In some embodiments, the disclosure provides a projection exposure apparatus capable of guiding illumination radiation with low loss.

In certain embodiments, the arrangement of all main components of the projection exposure apparatus are not in the same chamber. For example, by arranging the radiation source and projection optics in different chambers or rooms (e.g., one above the other), a sufficiently large optical distance between the radiation source and the illumination optics can be made available, without guiding the illumination radiation source in a main beam direction which is basically perpendicular to the direction of the illumination radiation before the reticle. It is therefore possible to avoid a relatively large adjustment of the main beam direction of the illumination radiation within the illumination optics. This can simplify the design of the illumination optics with high illumination radiation throughput. Because of the possibility of providing a large optical distance between the radiation source and the illumination optics, efficient screening of the downstream components of the projection exposure apparatus from unwanted particles or debris which the radiation source generates can take place there. Appropriate screening is known from US 2004/0108465 A1, U.S. Pat. No. 6,989,629 B1 and U.S. Pat. No. 6,867,843 B2. By housing the radiation source and projection optics in different chambers (e.g., one above the other), it is also possible to separate the supply of the radiation source spatially from those of the other components of the projection exposure apparatus, which is particularly advantageous for oscillation decoupling.

By arranging the illumination optics and/or the projection optics in a chamber different from (e.g., above) the radiation source, supplying the radiation source can be simplified, because shorter paths for whatever cooling water and heavy current feeds are involved can be achieved.

In some embodiments, it is possible to avoid an additional reflection mirror, since the illumination radiation from the radiation source can be sent through the leadthrough directly into the illumination optics, and passed on from there. In particular, two, four, six or eight reflection mirrors with correspondingly small angles of incidence can be provided. Optionally, separate illumination optics can even be omitted completely. In such embodiments, for example, after passing through the illumination radiation leadthrough, the illumination radiation, which the collector forms after the radiation source, hits the reticle directly without further bundle formation.

In certain embodiments, three or five reflection mirrors with correspondingly small angles of incidence can be provided. In principle, even illumination optics with precisely one reflection mirror with a correspondingly small angle of incidence are possible.

The advantages of the projection exposure apparatus can be particularly effective with certain radiation sources. In particular, a plasma generator, the EUV emission of which can be collected with a collector with a collection angle in the range from 40° to 75°, can be used as an EUV radiation source.

In certain embodiments, a vacuum leadthrough can give the possibility of obtaining a vacuum in one chamber, while the other chamber is ventilated (e.g., for assembly or maintenance work).

In some embodiments, a main beam angle can ensure the smallest possible effective deflection angle within the illumination optics. The main beam angle of the illumination radiation between the radiation source and the illumination optics can be practically the same as that between the illumination optics and the reticle. In this case, practically no effective deflection of the main beam of the illumination radiation is desired in the illumination optics, so that reflections can only occur near the perpendicular or near the grazing incidence. The angle between the main beam of the illumination radiation in the region of the leadthrough and the plane of the wall can be greater than 70° (e.g., greater than 80°, such as 90°).

Intermediate focus formation can allow for using an illumination radiation leadthrough with a relatively small width. This can simplify the construction of a vacuum leadthrough which is implemented there. A collector with long focal length is possible. Optionally, the numerical aperture at the intermediate focus is in the range from 0.075 to 0.12.

Depending on the design of the collector, its focal length and thus the position of the intermediate focus can be specified. In some embodiments, it is possible to use an illumination radiation leadthrough with a particularly small width. If the wall includes multiple layers, it can be advantageous to position the intermediate focus within the layer at which the leadthrough has a small opening or a small width. This can be a layer the processing of which is complex, or a layer in which the vacuum leadthrough is to be implemented.

In some embodiments, the radiation source is arranged in a chamber that is below the illumination and/or projection optics.

In certain embodiments, the radiation source is arranged in a chamber that is above the illumination and/or projection optics.

### BRIEF DESCRIPTION OF THE DRAWINGS

Embodiments are explained in more detail below with reference to the drawings, in which:

FIG. 1 shows schematically a projection exposure apparatus for microlithography, with a radiation source which is arranged in a chamber below the other main components of the projection exposure apparatus;

FIG. 2 shows, in greater detail, the bundle guidance of illumination radiation within the projection exposure apparatus according to FIG. 1, in the region of an illumination radiation leadthrough between the chambers and illumination optics;

FIG. 3 shows, in a similar representation to FIG. 2, bundle guidance of the illumination radiation;

FIG. 4 shows schematically the bundle guidance of illumination radiation between a radiation source and an image plane of the projection exposure apparatus, in which an intermediate focus of the illumination radiation between the radiation source and the illumination optics is arranged in a supporting layer of a wall which separates the chambers;

FIG. 5 shows, in a similar representation to FIG. 4, a projection exposure apparatus, in which the intermediate focus is in a service layer of the wall;

FIG. 6 shows, in a similar representation to FIG. 4, a projection exposure apparatus, in which the intermediate focus is arranged in the region of a boundary between the supporting layer and the service layer;

FIG. 7 shows, in a similar representation to FIG. 4, a projection exposure apparatus, in which the intermediate focus is arranged between the wall and the illumination optics;

FIG. 8 shows, in a similar representation to FIG. 4, a projection exposure apparatus, in which the intermediate focus is arranged in the region of a boundary wall on the exit side with respect to the beam direction of the illumination radiation;

FIG. 9 shows, in a similar representation to FIG. 1, a projection exposure apparatus, in which the radiation source is arranged in a chamber above the other components of the projection exposure apparatus; and

FIG. 10 shows, in a similar representation to FIG. 2, the bundle guidance of the illumination radiation through an illumination beam leadthrough in the region of a wall which separates the chambers, and in the region of illumination optics of the projection exposure apparatus according to FIG. 9.

### DETAILED DESCRIPTION

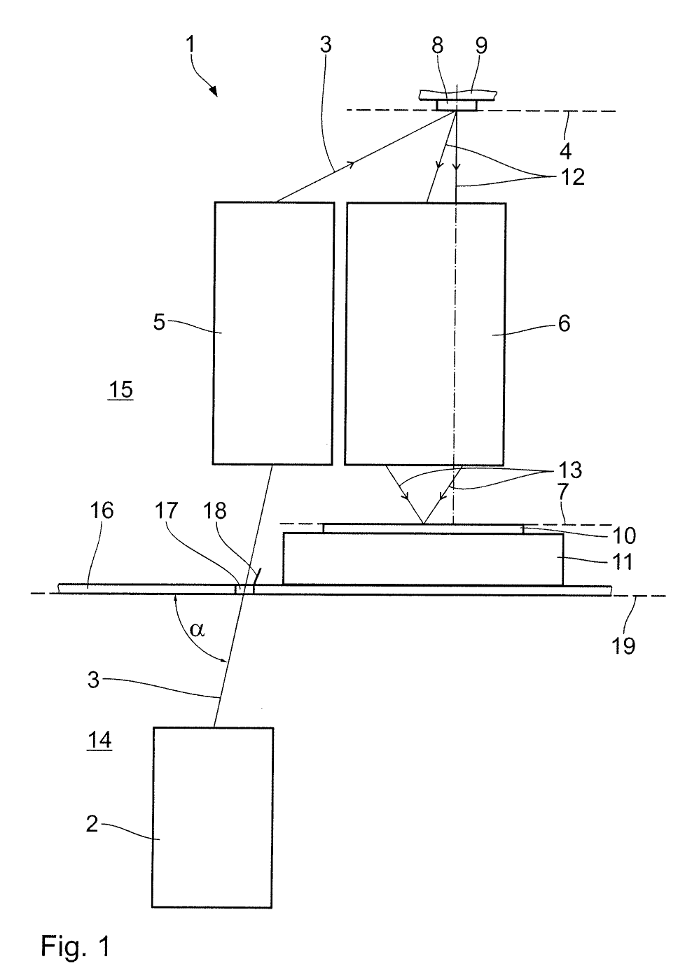

FIG. 1 shows schematically the main components of a projection exposure apparatus 1, which is used in the production of microstructured components, in particular microstructured integrated circuits. A radiation source 2 generates illumination radiation 3 in the form of a radiation bundle. The radiation source 2 is an EUV radiation source, which generates radiation in the extreme ultraviolet wavelength range, in particular between 10 nm and 30 nm. In FIG. 1, for simplicity, only a portion of a main beam of the illumination radiation 3 is shown.

The illumination radiation 3 is used to expose an object field in an object plane 4 of the projection exposure apparatus 1. The illumination radiation 3 is guided between the radiation source 2 and the object plane 4 by illumination optics 5. Projection optics 6 are used to image the object field into an image field in an image plane 7 of the projection exposure apparatus 1.

In the object plane 4, a reticle 8 is arranged, and its pattern surface to be imaged is in the object field. The reticle 8 is held by a reticle holder 9, a portion of which is shown in FIG. 1. In the image plane 7, a wafer 10 is arranged, and its surface to be exposed is in the image field. The wafer 10 is held by a wafer holder 11. In the embodiment according to FIG. 1, the reticle holder 9 is arranged above the wafer holder 11. The projection optics 6 are arranged between the reticle holder 9 and the wafer holder 11.

The projection exposure apparatus 1 can be implemented like a stepper or like a scanner.

In FIG. 1, the illumination radiation bundle which the projection optics 6 image is indicated by 12 and 13.

The radiation source 2 is in chamber 14, and the other main components of the projection exposure apparatus 1 are arranged in chambers 15. As shown in FIG. 1, chamber 15 is above chamber 14 (chambers 14 and 15 are different chambers. The chambers 14, 15 are separated from each other by a wall 16. An illumination radiation leadthrough 17, which is located in the wall 16, allows the illumination radiation 3 to pass therethrough to enter the illumination optics 5. When the projection exposure apparatus 1 is in operation, the chambers 14 and 15 are evacuated. Thus, the whole projection exposure apparatus 1 is then arranged in a vacuum. The illumination radiation leadthrough 17 is implemented as a vacuum leadthrough. It has a flap 18 or a gate valve, with which the illumination radiation leadthrough 17 can be sealed in a vacuum-tight manner. In this way, it is possible to ventilate one of the chambers 14, 15, retaining a vacuum in the other of the two chambers 14, 15 which can be used for maintenance or assembly work on components of the projection exposure apparatus 1.

The main beam of the illumination radiation 3 in the region of the leadthrough 17 makes an angle α, which in the embodiment shown in FIG. 1 is about 75°, to a plane 19 of the wall 16. Other angles α, in particular those greater than 60°, are possible. Angles α which are greater than 70° can be used. Angles α which are greater than 80° and up to 90°, i.e. a vertical and rectangular leadthrough of the illumination radiation 3 through the wall 16, are particularly advantageous. The angles α can also correspond to the angle of the main beam of the illumination radiation 3 after leaving the illumination optics 5 towards the reticle 8.

In the embodiment according to FIG. 1, the illumination radiation leadthrough 17 is provided in the wall 16, which supports the other main components of the projection exposure apparatus 1 apart from the radiation source 2, i.e. in particular the projection optics 6 and the illumination optics 5.

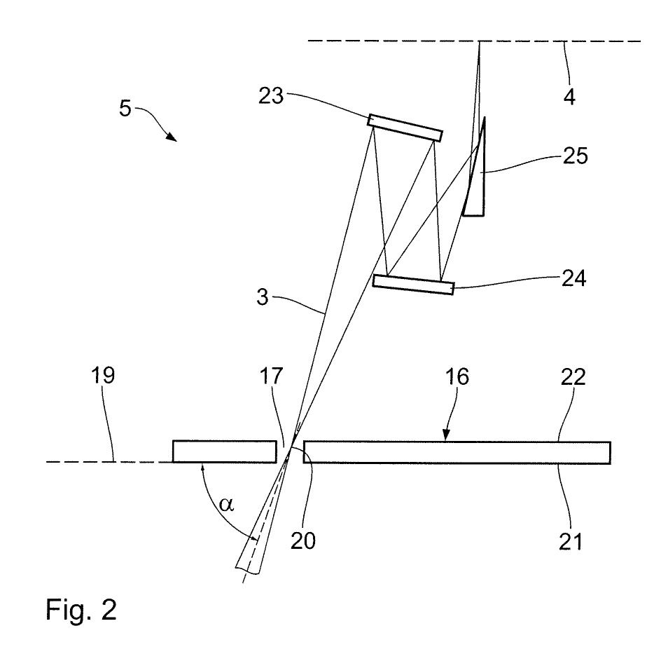

FIG. 2 shows closer details of the bundle guidance of the illumination radiation 3 in the region of the illumination radiation leadthrough 17 and the illumination optics 5. The illumination radiation 3 has an intermediate focus 20 in the region of the wall 16. The intermediate focus 20 is centrally between the planes of an entry-side 21 of wall 16 (in the radiation direction of the illumination radiation 3) and an exit-side 22 of the wall 16 (in the radiation direction of the illumination radiation 3).

In FIG. 2, the main beam of the illumination radiation 3 in the region of the leadthrough 17 has an angle α to the plane 19 of about 70°. In this detail, therefore, the radiation guidance according to FIGS. 1 and 2 differs.

The illumination optics 5 has a field facet mirror 23 and a pupil facet mirror 24. These two mirrors 23, 24 ensure defined illumination of the object field. Appropriate arrangements of the field facet mirror 23 and pupil facet mirror 24 are known to the person skilled in the art. The facet mirrors 23, 24 are reflection mirrors. The main beam angles of incidence of the illumination radiation 3 on the facet mirrors 23, 24 are less than 20°. In the embodiment according to FIG. 2, the main beam angle of incidence on the field facet mirror 23 is about 10°. The main beam angle of incidence on the pupil facet mirror 24 is about 19°.

Downstream from the pupil facet mirror 24 is a grazing incidence mirror 25 of the illumination optics 5. The mirror 25 deflects the illumination radiation 3 coming from the pupil facet mirror 24 onto the object field. The main beam angle of incidence of the illumination radiation 3 on the grazing incidence mirror 25 is significantly greater than 45°. In total, therefore, the illumination optics 5 according to FIG. 2 has exactly two reflection mirrors, i.e. the facet mirrors 23, 24, with main beam angles of incidence of the illumination radiation 3 which are less than 20°.

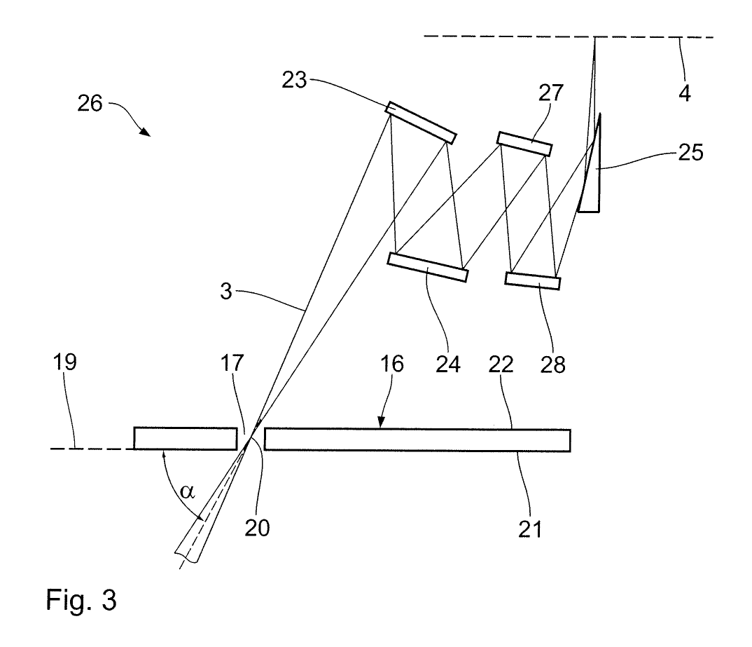

FIG. 3 shows another embodiment of illumination optics 26, which can be used instead of the illumination optics 5 with the projection exposure apparatus 1 according to FIG. 1. Components corresponding to those which have been explained above with reference to FIGS. 1 and 2 have the same reference numbers and are not discussed again in detail.

The main beam of the illumination radiation 3 in the region of the leadthrough 17 has an angle α to the plane 19 of the wall 16 of about 60°.

The illumination optics 26 has, in addition to the facet mirrors 23, 24, two further, down-stream reflection mirrors 27, 28 before the grazing incidence mirror 25. The main beam angle of incidence of the illumination radiation 3 on the facet mirror 23 is about 16° in the embodiment according to FIG. 3. The main beam angle of incidence of the illumination radiation 3 on the pupil facet mirror 24 is about 23°. The main beam angle of incidence of the illumination radiation 3 on the reflection mirror 27 is about 22°. The main beam angle of incidence of the illumination radiation 3 on the reflection mirror 28 is about 15°. The main beam angle of incidence of the illumination beam 3 on the grazing incidence mirror 25 is again significantly greater than 45°. The illumination optics 26 therefore has exactly four mirrors 23, 24, 27, 28 with angles of incidence of the illumination radiation 3 which are less than 25°.

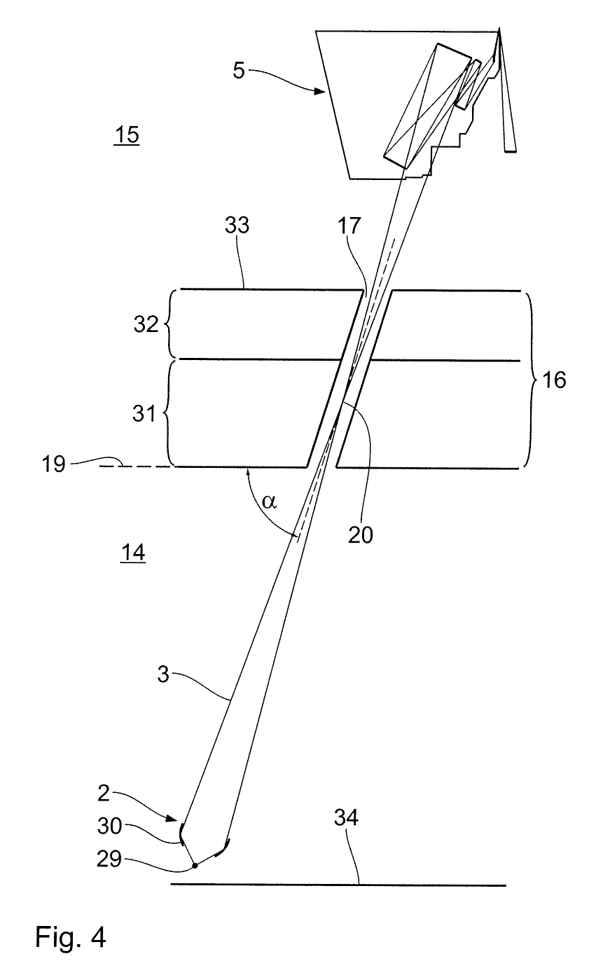

FIGS. 4 to 8 show different variants of beam guidance of the illumination radiation 3, differing mainly in the position of the intermediate focus relative to the boundary walls of the wall. Components corresponding to those which have been explained above with reference to FIGS. 1 to 3 have the same reference numbers and are not discussed again in detail.

As shown in FIGS. 4 to 8, the radiation source 2 has, as well as an actual radiation emitter 29, i.e. the place where the EUV radiation is generated, a collector 30, which collimates the illumination radiation 3 from the radiation emitter 29.

FIG. 4 shows the wall 16 enlarged relative to the other components of the projection exposure apparatus 1 and in more detail. The wall 16 is divided into a supporting layer 31 and a service layer 32. The supporting layer 31 is made of concrete. The service layer 32 is arranged on the supporting layer 31. The service layer 32 includes a service surface (floor) 33, on which it is possible to walk, and which is supported via retaining walls (not shown) on the supporting layer 31. The service surface 33 can be removed in sections, so that a region below the service layer 32 (in which there are supply lines, for instance) is accessible.

The radiation source 2 is supported by a floor 34 of the lower chamber 14.

The collimating effect of the collector 30 is such that the intermediate focus 20 is central in the supporting layer 31 in the embodiment according to FIG. 4. The illumination radiation leadthrough 17 can therefore be implemented with an advantageously small width in the region of the supporting layer 31. This reduces the production cost of the illumination radiation leadthrough 17.

An angle α between the main beam of the illumination beam 3 in the region of the leadthrough 17 and the plane 19 is about 75° in the embodiment according to FIG. 4.

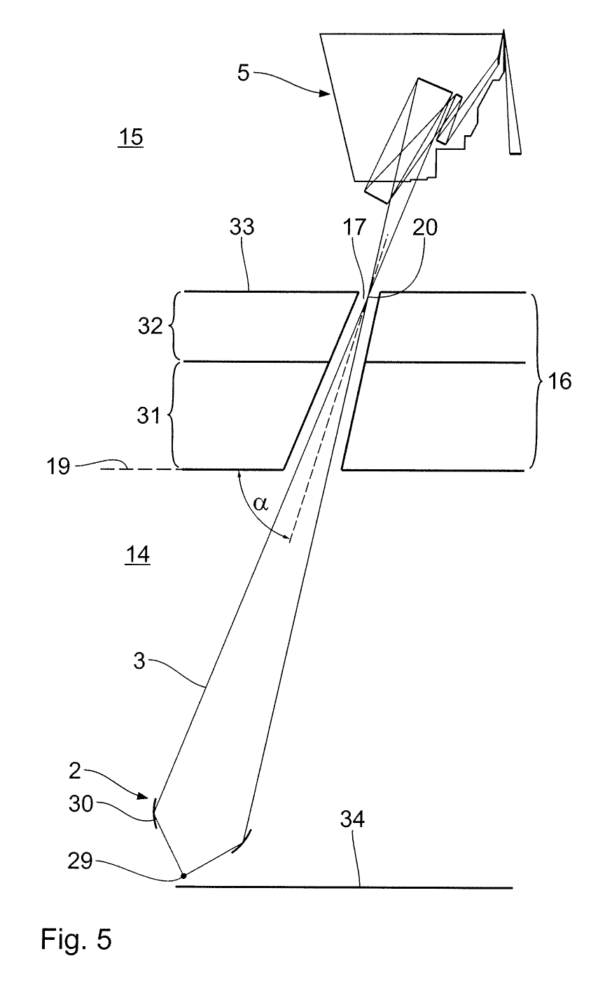

The embodiment according to FIG. 5 differs from the one according to FIG. 4 basically by the form of the collector 30. In the embodiment according to FIG. 5, the collector has a greater diameter and, compared with the collector 30 according to FIG. 4, a weaker collimating effect, i.e. a longer focal length. The result of this is that in the embodiment according to FIG. 5 the intermediate focus 20 is within the service layer 32. The leadthrough 17 can then be implemented in the region of the service layer 32 with a small width.

An angle α between the main beam of the illumination beam 3 in the region of the leadthrough 17 and the plane 19 is about 75° in the embodiment according to FIG. 5.

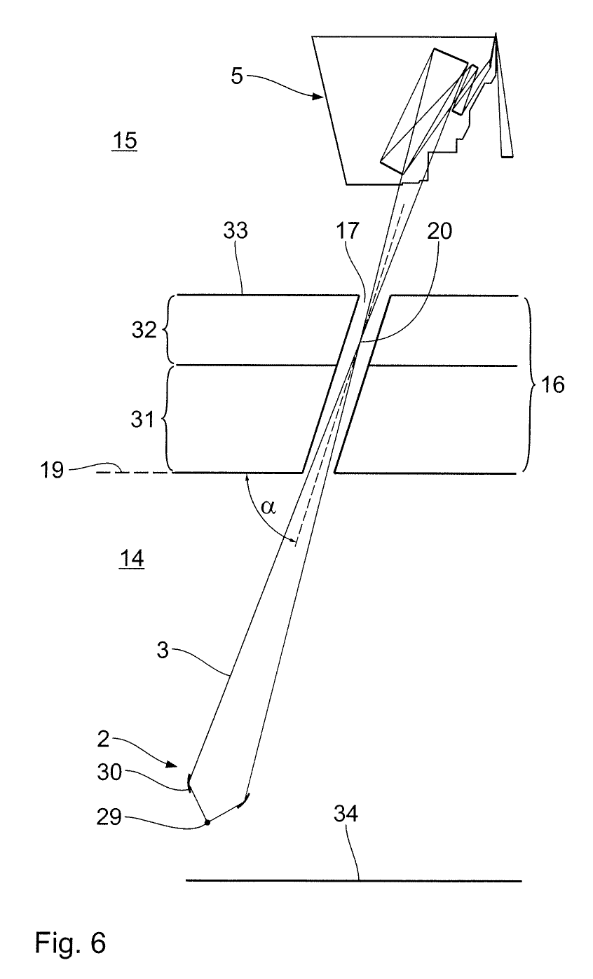

The embodiment according to FIG. 6 also differs from the one according to FIG. 4 basically by the collimating effect of the collector 30. In the embodiment according to FIG. 6, this is somewhat smaller than in the embodiment according to FIG. 4, so the intermediate focus 20 in the embodiment according to FIG. 6 is at the transition between the supporting layer 31 and the service layer 32. In this case, the leadthrough 17 can be implemented with a small width through the whole wall 16.

An angle α between the main beam of the illumination beam 3 in the region of the leadthrough 17 and the plane 19 is about 75° in the embodiment according to FIG. 6.

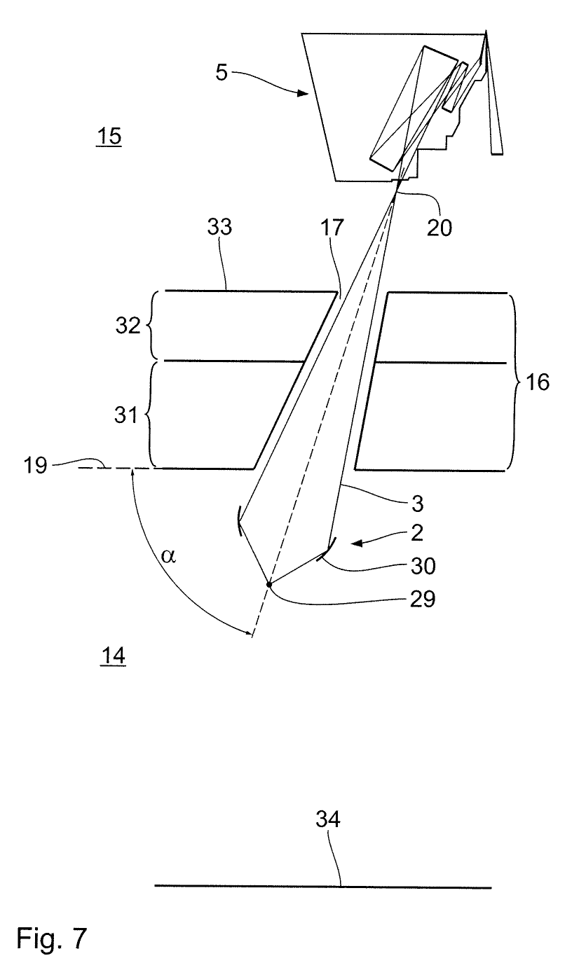

In the embodiment according to FIG. 7, the collector 30 is arranged relative to the illumination optics 5 so the intermediate focus 20 is between the wall 16 and the illumination optics 5.

An angle α between the main beam of the illumination beam 3 in the region of the leadthrough 17 and the plane 19 is about 75° in the embodiment according to FIG. 7.

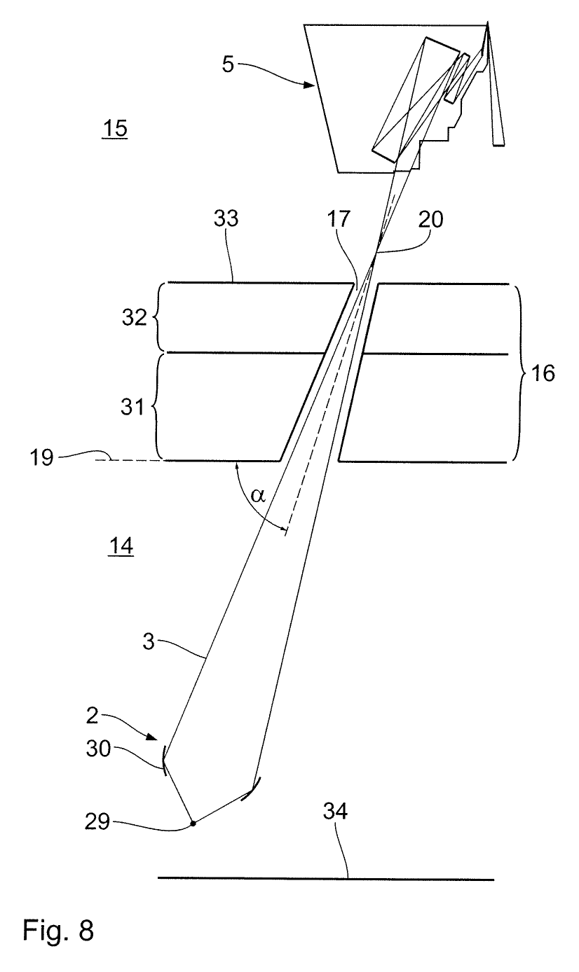

The embodiment according to FIG. 8 also differs from the one according to FIG. 4 basically by the collimating effect of the collector 30. In the embodiment according to FIG. 8, this is such that the intermediate focus 20 is arranged in the region of the service surface 33. The opening of the illumination radiation leadthrough 17 is then minimally wide in the region of the service surface 33.

An angle α between the main beam of the illumination beam 3 in the region of the leadthrough 17 and the plane 19 is about 75° in the embodiment according to FIG. 8.

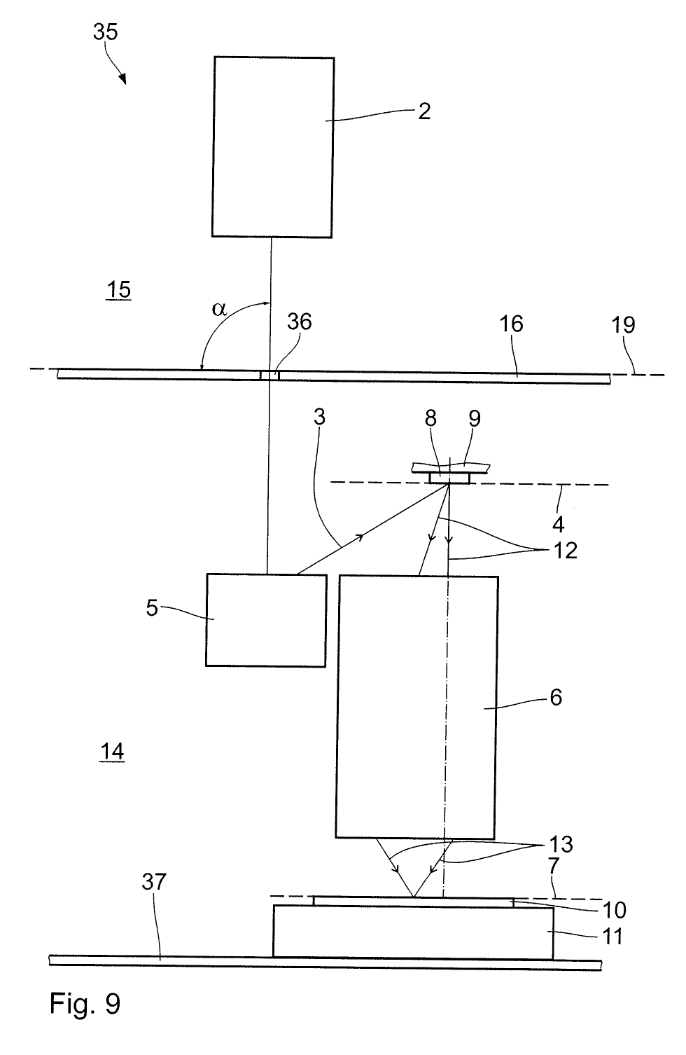

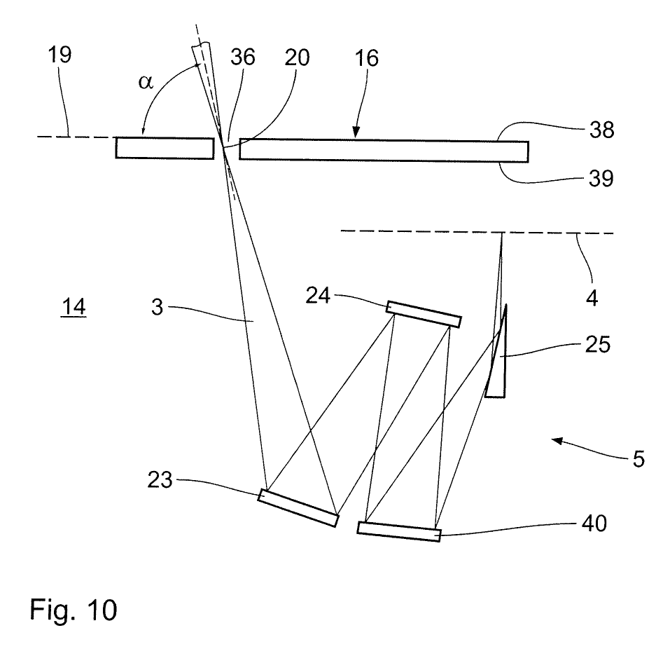

FIGS. 9 and 10 show a projection exposure apparatus 35. Components corresponding to those which have been explained above with reference to FIGS. 1 to 8 have the same reference numbers and are not discussed again in detail.

In the case of the projection exposure apparatus 35, the radiation source 2 is arranged in the upper chamber 15, and the other main components of the projection exposure apparatus 35, in particular the illumination optics 5 and the projection optics 6, are arranged in the chamber 14 therebelow. Correspondingly, an illumination radiation leadthrough 36, which corresponds in function to the illumination radiation leadthrough 17, is in turn arranged in the wall 16 which separates the two chambers 14, 15 from each other. In the embodiment according to FIG. 9, the wall 16 is arranged above a wall 37, which supports the wafer holder 11 and the optical systems 5 and 6. The illumination radiation 3 is therefore fed from a chamber which is above the chamber in which the other components of the projection exposure apparatus 35 are arranged.

The angle α between the main beam of the illumination radiation 3 in the region of the leadthrough 36 and the plane 19 is 90° in the embodiment according to FIG. 9.

FIG. 10 shows, in a similar representation to FIGS. 2 and 3, details of the bundle guidance of the illumination radiation 3 in another embodiment of a projection exposure apparatus, in which the radiation source is also above the illumination optics. Components and reference magnitudes corresponding to those which have been explained above with reference to FIGS. 1 to 9 have the same reference numbers and are not discussed again in detail. In the embodiment according to FIG. 10, the illumination radiation 3 similarly comes from above through the illumination radiation leadthrough 36. The intermediate focus 20 is arranged centrally between an entry-side boundary wall 38 and an exit-side boundary wall 39 of the wall 16. The main beam of the illumination radiation 3 in the embodiment according to FIG. 10 has, in the region of the leadthrough 36, an angle α to the plane of about 75°.

In the embodiment according to FIG. 10, unlike the embodiments according to FIGS. 2 to 8 described above, an even number of mirrors with small angles of incidence is not provided, but an odd number of such mirrors. After passing through the illumination radiation leadthrough 36, the illumination radiation 3 first hits the field facet mirror 23 and then the pupil facet mirror 24. Downstream therefrom are a further reflection mirror 40 and the grazing incidence mirror 25.

The angle of incidence of the illumination radiation 3 on the field facet mirror 23 is about 24°. The angle of incidence of the illumination radiation 3 on the pupil facet mirror 24 is about 14°. The angle of incidence of the illumination radiation 3 on the reflection mirror 40 is about 1°. The angle of incidence of the illumination radiation 3 on the grazing incidence mirror 25, also in the embodiment according to FIG. 10, is significantly greater than 45°.

Also in the embodiments according to FIGS. 9 and 10, the reticle holder 9 is arranged above the wafer holder 11, and the projection optics 6 is arranged between the reticle holder 9 and the wafer holder 11.

In the embodiments according to FIGS. 1 to 10, a device is associated with or down-stream from the radiation source 2, to prevent impurities which the radiation emitter 29 generates being able to follow the further course of the illumination radiation 3.

Corresponding devices are known to the person skilled in the art, and described, for instance, in publications US 2004/0108465 A1, U.S. Pat. No. 6,989,629 B1 and U.S. Pat. No. 6,867,843 B2.

1. A projection exposure apparatus, comprising:
a housing including a wall that defines first and second chambers, the wall having an opening;
a radiation source to generate radiation, the radiation source being in the first chamber;
illumination optics in the second chamber so that radiation generated by the radiation source can pass through the opening in the wall and enter the illumination optics; and
projection optics in the second chamber,
wherein the projection exposure apparatus is configured to be used in microlithography.

2. The projection exposure apparatus according to claim 1, wherein the illumination optics are above the radiation source.

3. The projection exposure apparatus according to claim 1, wherein the projection optics are above the radiation source.

4. The projection exposure apparatus according to claim 2, wherein the illumination optics comprise an even number of reflection mirrors.

5. The projection exposure apparatus according to claim 4, wherein, for each of the reflection mirrors, radiation generated by the radiation source has a main beam angle of incidence that is smaller than 25°.

6. The projection exposure apparatus according to claim 1, wherein the illumination optics are below the radiation source.

7. The projection exposure apparatus according to claim 1, wherein the projection optics are below the radiation source.

8. The projection exposure apparatus according to claim 6, wherein the illumination optics comprises an odd number of reflection mirrors.

9. The projection exposure apparatus according to claim 8, wherein, for each of the reflection mirrors, radiation generated by the radiation source has a main beam angle of incidence that is smaller than 25°.

10. The projection exposure apparatus according to claim 1, wherein the radiation source is an EUV radiation source.

11. The projection exposure apparatus according to claim 1, further comprising a device capable of covering the hole in the wall to provide a vacuum-tight seal between the first and second chambers.

12. The projection exposure apparatus according to claim 1, wherein, during use, a main beam of radiation generated by the radiation source makes an angle relative to a plane of the wall that is greater than 60° in a region of the wall.

13. The projection exposure apparatus according to claim 1, further comprising a collector, wherein the radiation source comprises a radiation emitter, the collector is down-stream from the radiation emitter, and the collector is configured to form radiation generated by the radiation source to have an intermediate focus in a region of the hole in the wall.

14. The projection exposure apparatus according to claim 13, wherein the intermediate focus is centrally located between an exit side of the wall and an entry side of the wall.

15. The projection exposure apparatus according to one of claim 1, wherein the wall supports the illumination optics and/or the projection optics.

16. The projection exposure apparatus according to claim 1, further comprising:
a first holder configured to receive a reticle in an object plane of the illumination optics; and
a second holder configured to receive a wafer in an image plane of the projection optics.

17. The projection exposure apparatus according to one of claim 16, wherein the first holder is above the second holder, and the projection optics are between the first and second holders.

18. The projection exposure apparatus of claim 17, wherein the illumination optics comprises an even number of reflection mirrors, and, for each of the reflection mirrors, radiation generated by the radiation source has a main beam angle of incidence that is smaller than 25°.

19. The projection exposure apparatus according to claim 1, wherein the wall having a hole therein is above a wall that supports the illumination optics and/or the projection optics.

20. The projection exposure apparatus according to claim 19, further comprising:
a first holder configured to receive a reticle in an object plane of the illumination optics; and
a second holder configured to receive a wafer in an image plane of the projection optics.

21. The projection exposure apparatus according to claim 20, wherein the first holder is above the second holder, and the projection optics are between the first and second holders.

22. The projection exposure apparatus of claim 21, wherein the illumination optics comprises an odd number of reflection mirrors, and, for each of the reflection mirrors, radiation generated by the radiation source has a main beam angle of incidence that is smaller than 25°.

23. A projection exposure apparatus, comprising:
a radiation source configured to generate illumination radiation;
illumination optics configured to bundle guide the illumination radiation to an object field so that an object plane of the object field is illuminated with the illumination radiation; and
projection optics configured to image the object field into an image field in an image plane of the projection optics,
wherein the radiation source is in a first chamber, the illumination optics and/or the projection optics are in a second chamber separated from the first chamber by a wall, the wall has a hole in it, and the projection exposure apparatus is configured to be used in microlithography.

24. The projection exposure apparatus of claim 23, further comprising:
a reticle holder configured to receive a reticle in the object plane; and
a wafer holder configured to receive a wafer in the image plane.

25. A projection exposure apparatus, comprising:
a radiation source configured to generate radiation;
illumination optics configured to guide the radiation generated by the radiation source; and
projection optics,
wherein the radiation source is in a first chamber, the illumination optics and/or the projection optics are in a second chamber separated from the first chamber by a wall, the wall has a hole in it, and the projection exposure apparatus is configured to be used in microlithography.
